(19) United States
(12) Patent Application Publication
(10) Pub. No.: US 2011/0231292 A1
(43) Pub. Date: Sep. 22, 2011

(54) SYSTEMS, APPARATUS, AND METHODS FOR PROXIMITY-BASED PEER-TO-PEER PAYMENT TRANSACTIONS

(76) Inventor: Steven Harvey McCown, Rigby, ID (US)

(21) Appl. No.: 13/069,160

(22) Filed: Mar. 22, 2011

Related U.S. Application Data
(60) Provisional application No. 61/316,305, filed on Mar. 22, 2010.

(51) Int. Cl. G06Q 30/00; G06Q 20/00

(52) U.S. Cl. 705/27.1; 705/26.1

(57) ABSTRACT

In a system, method, GUI, apparatus, and/or computer-readable media for providing a secure, proximity based peer-to-peer payment transaction service a signal may be received from a personal electronic device (PED) by a server. An identity of the PED may be verified based on the received signal and, upon verification the PED may be enabled to discover one or more offers to participate in a transaction provided by one or more sellers. A selection and acceptance of an offer may be received from the PED and funds to a seller providing the selected offer.

### RELATED APPLICATION

This application is a NONPROVISIONAL of, claims priority to, and incorporates by reference U.S. Provisional Patent Application 61/316,305 filed 22 Mar. 2010.

### FIELD OF INVENTION

The present invention relates to systems, methods, graphical user interface (GUI), apparatus, and computer-readable media for providing a secure, proximity based peer-to-peer payment transaction service.

### BACKGROUND

Mobile communication services for telephony and Internet access have become ubiquitous. Mobile phones, personal digital assistants, and other personal electronic devices are commonly used to conduct transactions across a mobile network and/or the Internet, in circumstances where the device user is in communication with a financial institution such as a bank, brokerage, or other commercial enterprise. However, secure means by which an individual buyer and a seller may carry out a transaction electronically without, for example, an intermediary credit card company or financial institution and without risk of compromising personal and/or financial information do not exist.

Presently, small merchant users or occasional sellers may not be able to enroll with the credit card companies to accept and process credit cards for their businesses or occasional sales due to the cost or complexity of signing up for or maintaining credit card merchant accounts. Additionally, there is a high risk to these merchants in handling credit card numbers due to the ramifications if those numbers are lost or stolen.

### BRIEF DESCRIPTION OF THE FIGURES

The present application is illustrated by way of example, and not limitation, in the figures of the accompanying drawings in which:

FIGS. 1A-1C are block diagrams illustrating exemplary systems consistent with embodiments of the present application;

FIG. 2 is a block diagram illustrating an exemplary personal electronic device, consistent with embodiments of the present invention;

FIGS. 3-7 are diagrams of exemplary GUIs, consistent with embodiments of the present invention; and

FIGS. 8-10 are flowcharts illustrating exemplary processes, consistent with embodiments of the present invention.

Throughout the drawings, the same reference numerals and characters, unless otherwise stated, are used to denote like features, elements, components, or portions of the illustrated embodiments. Moreover, while the subject invention will now be described in detail with reference to the drawings, the description is done in connection with the illustrative embodiments. It is intended that changes and modifications can be made to the described embodiments without departing from the true scope and spirit of the subject invention as defined by the appended claims.

### SUMMARY

Systems, apparatus, GUI, computer readable media, and methods for proximity-based peer-to-peer payment transactions are herein provided. A signal from a personal electronic device (PED) may be received by, for example, a server and an identity of the PED and/or a user of the PED may be verified based on the received signal according to, for example, one or more security protocols. Exemplary PEDs include portable communication devices, mobile telephones, laptop computers, tablet computers, computerized wristwatches, and portable music players. Exemplary security protocols could include secure sockets layer (SSL), digital signature calculation and verification, electronic signature verification, cryptographic hash protocols, password protocols, encryption and decryption algorithms, and other similar security protocols, each of which is well known in the art.

When the identity of the PED is verified, the PED may be enabled to discover one or more offers to participate in a transaction (including, for example, a financial transaction) provided by one or more sellers. Exemplary offers can include a description of an item, a price of an item, a quantity of items, a quantity of items available for sale, a seller identity, a logo, an icon representative of an item, a date, a range of dates, an offer to participate in an auction for the purchase or sale of an item, an expiration date, a location, a discount, an offer to become a member in an organization, and/or a coupon.

In one embodiment, verification of an identity of the PED may include verifying, for example, a token, a personal identification number (PIN), and/or a password received from the PED. In another embodiment, verification of identity of the PED may include, for example, accessing credentials associated with the PED and verifying the accessed credentials.

Discovery of one or more offers may include scanning, by the PED, for one or more sellers and receiving a signal from at least one seller. The signal may include, for example, identification information associated with the seller, a transaction identifier, and/or an offer to participate in the transaction.

The PED may be enabled to discover the one or more sellers via, for example, a wireless communication protocol, Bluetooth communication (as is well known in the art), wireless fidelity (WiFi) communication (also as is well known in the art), cell phone identifier discovery, near field communication (NFC) chip identifier discovery, radio frequency identifier (RFID) discovery, location-based discovery, and/or location based or global positioning (GPS) discovery.

On some occasions, the identity of the seller may be verified according to, for example, one or more security protocols. On other occasions, an identifier may be received from the seller and provided to the PED in the form of, for example, a name, a logo, a trademark, an image, and/or an avatar.

A selection of at least one of the offers may be received from the PED by the seller and, in-some embodiments, further details regarding a selected offer may be provided to the PED. An acceptance of a selected offer may then be received from the PED by the seller.

Following acceptance of the offer, funds may be transferred to a seller providing the selected offer in accordance with, for example, one or more terms of the selected offer. In some cases, funds may be transferred from an account with a financial institution associated with the PED to an account with a financial institution associated with the seller.

In one embodiment, an offer may be received from a seller. An exemplary offer received from a seller may include identification information associated with the seller, a transaction identifier, and/or a description of the offer. Once the offer is received, the seller may be discoverable by the PED.

In one embodiment, communication by the PED and/or the seller with a device other than the server may be disabled until the transfer of funds to the seller is complete. Disabling communication in this way may act as a security precaution in order to prevent unintended capture of information transmitted during the process of, for example, transmitting identifying information, accepting an offer, and/or transferring funds to the seller.

In a further embodiment, a payment proxy service may be used to facilitate the transferring of funds to the seller. In this embodiment, acceptance of the offer may be transmitted to the proxy payment service. The identification of the PED may then be verified by the proxy payment service. When the PED is verified, the proxy payment service may access an account with a financial institution associated with the PED and withdraw the funds from the accessed account. The withdrawn funds may then be transferred to an account with a financial institution associated with the seller.

In yet another embodiment, the signal, selection, and/or acceptance of the offer may be received via a device other than the PED in a relay-type fashion. Implementation of this embodiment may be advantageous when, for example, the PED and/or seller are unable to wirelessly communicate with one another and/or a server. In this embodiment, the signal, selection, and/or acceptance may not be stored on the device other than the PED for security purposes.

In a further embodiment, a signal may be received from a PED and an identity of the PED may be verified based on the received signal. The PED may then be enabled to discover one or more sellers. A seller may be selected and it may be determined whether any offers to participate in a transaction are associated with the selected seller. Offers associated with the selected seller may then be provided to the PED. An acceptance of an offer may be received from the PED and funds may be transferred to the seller in accordance with, for example, the accepted offer.

An exemplary graphical user interface GUI disclosed herein may be presented to user via a PED. The exemplary GUI may include a first selectable option for transmitting a signal from the PED to a server, a selectable list of offers to participate in a transaction provided by one or more sellers discoverable by the PED, and a second selectable option for accepting at least one offer included in the list of offers.

On some occasions, the exemplary GUI may also include a first text box via which a seller enters information associated with at least one offer included in the list of offers and a second text box via which the seller enters information associated with an account the seller has with a financial institution.

Exemplary apparatus disclosed herein may be configured to, for example, receive a signal from a PED, verify an identity of the PED based on the received signal, enable, upon verification of the PED, the PED to discover one or more offers to participate in a transaction provided by one or more sellers, receive a selection of at least one of the offers from the PED, receive an acceptance of a selected offer from the PED, and transfer funds to a seller providing the selected offer.

Exemplary systems disclosed herein may include a PED and a server communicatively coupled to one another. The PED may be configured to, for example, transmit a signal to a server, discover one or more offers to participate in a transaction provided by one or more sellers, transmit a selection of at least one of the offers to the server, and transmit an acceptance of a selected offer to the server.

The server may be configured to, for example, receive a signal from a PED, verify an identity of the PED based on the received signal, enable, upon verification of the PED, the PED to discover the one or more offers to participate in a transaction provided by the one or more sellers, receive a selection of at least one of the offers from the PED, receive an acceptance of a selected offer from the PED, and transfer funds to a seller providing the selected offer.

### Written Description

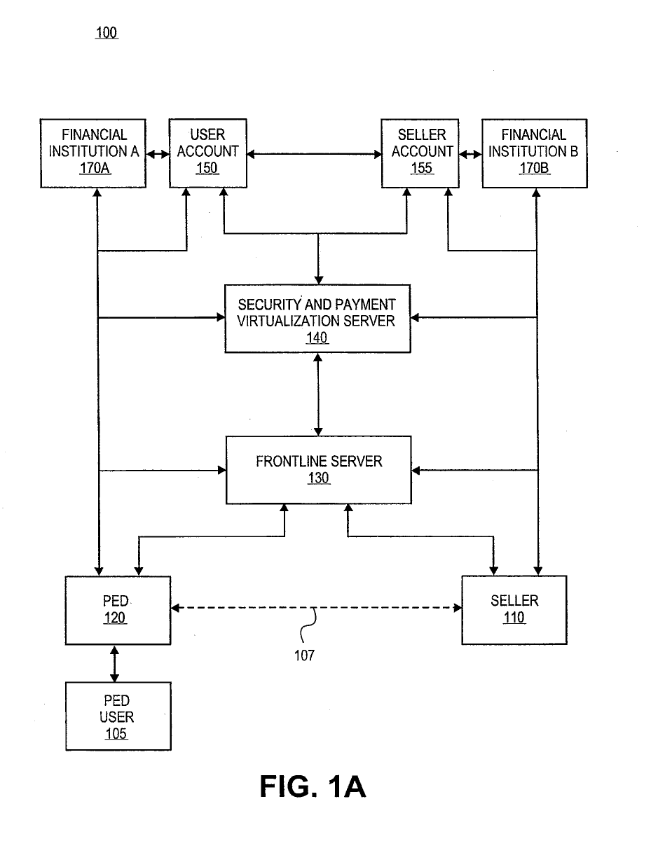

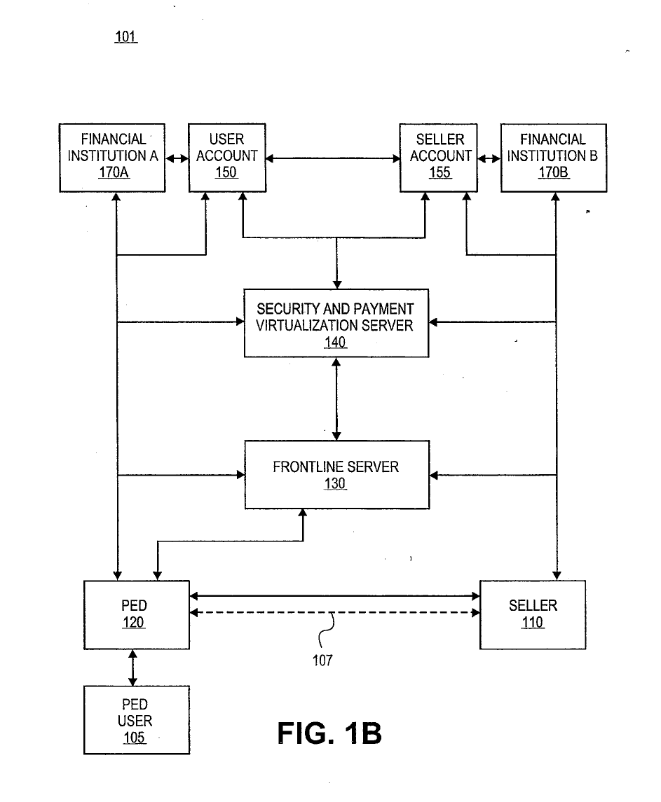

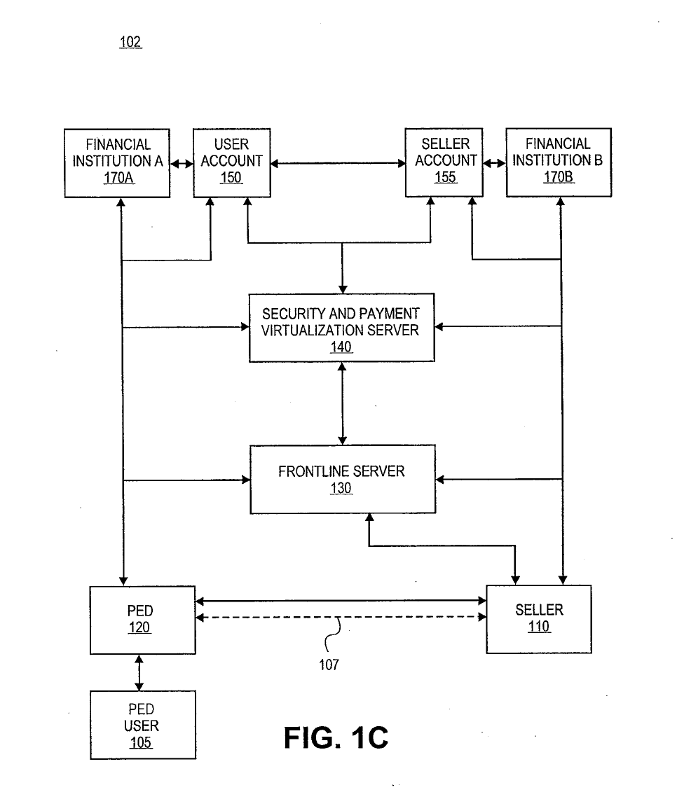

FIG. 1A is a block diagram illustrating an exemplary system 100 within which any one or more of the methodologies discussed herein may be executed. System 100 includes a personal electronic device (PED) 120, a PED user 105, a seller 110, a communication relay 107, a frontline server 130, security and payment virtualization server 140, a user account 150, a seller account 155, a financial institution A 170A, a financial institution B 170B, and multiple communication links operating to communicatively couple two or more components of system 100 with one another. The communication links and/or communication relay 107 may be wired or wireless.

PED 120 may be any device operable by PED user 105 and capable of discovering seller 110 and communicating with frontline server 130. Exemplary PEDs 120 include a portable communication device, a mobile telephone, a smartphone, a laptop computer, a tablet computer, a computerized wristwatch, and a portable music player.

PED 120 may be enabled to discover seller 110 via communication relay 107 which may be, for example, a wireless communication link, a wired communication link, and/or a physically close or actual physical connection between seller 110 and PED 120 (e.g., touching or “bumping”). In some embodiments, communication relay 107 may act only to facilitate the discovery of seller 110 by PED 120. In other words, communication relay 107 may not be a fully enabled communication link established for the purpose of exchanging information between PED 120 and seller 110 and, in some cases, for security purposes (e.g., when the communication protocol used to establish communication relay 107 does not support encrypted communications), may only be used to discover, and not communicate with, seller 110.

In some cases, PED 120 may transmit or receive a “broadcast identifier code” and thereby discover seller 110 via a return transmission by seller 110. The discovery of seller 110 may include, for example, detecting a signal transmitted by seller 110 via a wireless communication protocol, such as, for example, Bluetooth or WiFi. On some occasions, discovery of seller 110 may be executed by PED 120 via one or more of cell phone identifier discovery, near field communication (NFC) chip identifier discovery, radio frequency identifier discovery, location-based discovery, and global positioning (GPS) discovery. Once discovered, PED 120 may transmit discovery and/or identification information received from discovered seller 110 to frontline server 130 for verification and/or correlation with any offers associated with discovered seller 110.

Seller 110 may be any device capable of being detected by PED 120 and enabled to communicate with frontline server 130. Exemplary sellers include a portable communication device, a mobile telephone, a point-of-sale transaction device, a smartphone, a laptop computer, a tablet computer, a computerized wristwatch, and a portable music player that are operated by, for example individuals attempting to sell an item, retail establishments, auctioneers, vendors, and merchants.

Financial institutions A 170A and B 170B, respectively, may be any institution or entity enabled to conduct transactions with, for example, user account 150, seller account 155, frontline server 130, PED 120, seller 110, and/or security and payment virtualization server 140. Exemplary financial institutions A 170A and B 170B include banks, credit card companies, and credit unions.

Security and payment virtualization server 140 may be any system via which a proxy payment or funds transfer may be transacted. Exemplary security and payment virtualization servers 140 include PayPal™, Google Checkout™, Amazon™ payments, and Facebook™ payments. A PED user may enroll in and/or maintain one or more user accounts 150 with frontline server 130, security and payment virtualization server 140, and/or financial institution A 170A. PED user 105 and may make payments and/or transfer funds to, for example, seller account 155 and/or financial institution B 170B via, for example, user account 150, frontline server 130, security and payment virtualization server 140, and/or financial institution A 170A. In some embodiments, user 105 may place funds into and/or recharge user account 150. Likewise, a seller may enroll in and/or maintain one or more seller accounts 155 with frontline server 130, security and payment virtualization server 140, and/or financial institution B 170B and may receive payments and/or transferred funds via, for example, frontline server 130, security and payment virtualization server 140, financial institution A 170A, and/or user account 150. Data entered by a PED user and/or seller during an enrollment or maintenance process may be stored in, for example, frontline server 130, security and payment virtualization server 140, user account 150, seller account 155, and/or financial institutions A/B 170A/170B.

Frontline server 130 may be enabled to verify a PED 120 and/or seller 110 identities and may manage cryptographic material in relation to, for example, the verification. In some embodiments, frontline server 130 may be an Internet-facing server and/or firewall.

Frontline server 130 may be enabled to receive and store offers from one or more sellers 110 and may further be enabled to correlate received seller identification information with offers associated with a particular seller.

Frontline server 130 may be enabled to receive a message from, for example, PED 120 including a request for funds from security and payment virtualization server 140 and PED identification information associated with a user requesting the funds. Frontline server 130 may also be enabled to verify the accuracy of received PED identification information independently and/or via communication with security and payment virtualization server 140, financial institution A 170A and/or user account 150.

Upon receiving a request for funds from, for example, frontline server 130 via PED 120, security and payment virtualization server 140 may, for example, verify the identity of PED 120, verify the identity of PED user 105, verify the validity of the request, access user account 150, request funds from user account 150 and/or financial institution A 170A, verify that there are funds in user account 150 are sufficient to meet the amount of requested funds, receive the requested funds from user account 150 and/or financial institution A 170A, and/or transfer the requested funds to seller account 155, and/or financial institution B 170B.

Frontline server 130 may also be enabled to transmit a message to, for example, security and payment virtualization server 140 indicating the request for funds and/or verification of PED's identity. Frontline server 130 may then receive, directly or indirectly, the requested funds from, for example, security and payment virtualization server 140, user account 150, and/or financial institution A 170A and may transfer the received funds to, for example, seller 110, seller account 155, and/or financial institution B 170B.

In one embodiment frontline server 130 may also transmit a message to seller 110 and/or PED 120 indicating a transfer of funds and/or completion of a transaction. This message may resemble a receipt.

FIG. 1B is a block diagram illustrating an exemplary system 101 within which any one or more of the methodologies discussed herein may be executed. The components of system 101 are similar to those of system 100 with the exception that seller 110 is not communicatively coupled to frontline server 130 and is communicatively coupled to PED 120. The communicative link between PED 120 and seller 110 (shown in FIG. 1B as a solid line) serves to act as a relay for communication between seller 110 and frontline server 130. Such a relay may be necessary when, for example, seller 110 is not enabled to communicate with frontline server 130. This may occur when, for example, seller 110 is not directly connected to frontline server 130.

On some occasions, communications along communication relay 107 may be conducted via the communication link between seller 110 and PED 120. Typically, the communications relayed by PED 120 may not be stored by PED 120 and may be encrypted so that they are not understandable by PED 120.

FIG. 1C is a block diagram illustrating an exemplary system 102 within which any one or more of the methodologies discussed herein may be executed. The components of system 102 are similar to those of system 100 with the exception that PED 120 is not communicatively coupled to frontline server 130 and is communicatively coupled to seller 110. The communicative link between PED 120 and seller 110 (shown in FIG. 1C as a solid line) serves to act as a relay for communication between PED 120 and frontline server 130. Such a relay may be necessary when, for example, PED 120 is not enabled to communicate with frontline server 130. This may occur when, for example, PED 120 is not wirelessly enabled.

On some occasions, communications along communication relay 107 may be conducted via the communication link between seller 110 and PED 120. Typically, the communications relayed by seller 110 may not be stored by seller 110 and may be encrypted so that they are not understandable by seller 110.

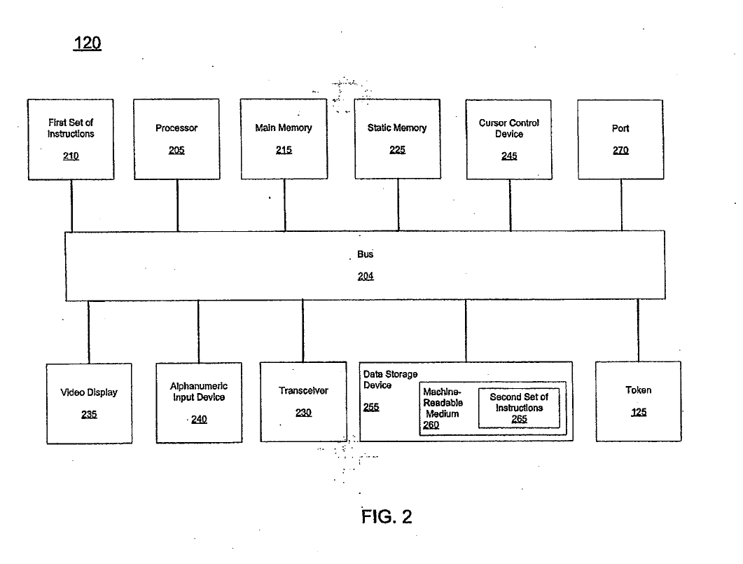

FIG. 2 is a block diagram illustrating an exemplary PED 120 within which a first set of instructions 210 may be executed for causing PED 120 to perform any one or more of the methodologies discussed herein. In alternative embodiments, PED 120 operates as a standalone device or may be connected (e.g., via network or communication link) to other machines and/or communication devices. PED 120 may be, for example, a mobile communication device, a mobile phone, a smart phone, a key fob, a Radio-frequency identification (RFID) enabled device, a magnetic key card, a tablet computer, a laptop computer, a personal digital assistant (PDA), a cellular telephone, or any communication device capable of executing a set of instructions (sequential or otherwise) that specify actions to be taken by that communication device. Further, while only a single PED 120 is illustrated, the term communication device shall also be taken to include any collection of machines that individually or jointly execute a set (or multiple sets) of instructions to perform any one or more of the methodologies discussed herein.

Exemplary PED 120 can include a processor 205 (e.g., a central processing unit (CPU), a graphics processing unit (GPU), or both), a main memory 215 (e.g., read-only memory (ROM), flash memory, dynamic random access memory (DRAM) such as synchronous DRAM (SDRAM) or Rambus DRAM (RDRAM), etc.), and a static memory 225 (e.g., flash memory, static random access memory (SRAM), etc.), which communicate with each other via a bus 204.

PED 120 may further include a video display 235 (e.g., a liquid crystal display (LCD), an LCD capacitive touchscreen, or a light emitting diode (LED) display). PED 120 may also include an alphanumeric input device 240 (e.g., a keyboard or capacitive touchscreen), a cursor control device 245 (e.g., a track pad, or capacitive touchscreen), a data storage device 255, and a transceiver 230.

Data storage device 255 can include a machine-readable medium 260 in which is stored one or more second sets of instructions 265 (e.g., software or firmware) embodying any one or more of the methodologies or functions described herein. Second set of instructions 265 may also reside, completely or at least partially, within main memory 215 and/or within processor 205 during execution thereof by PED 120, static memory 225, and processor 205 also constituting machine-readable media. Second set of instructions 265 may further be transmitted or received over a network (not shown) via transceiver 230.

While first set of instructions 210 are shown in an exemplary embodiment to be on a single medium, the term “machine-readable medium” should be taken to include a single medium or multiple media (e.g., a centralized or distributed database or data source and/or associated caches and servers) that store the one or more second sets of instructions 265. The term “machine-readable medium” shall also be taken to include any medium that is capable of storing, encoding, or carrying a set of instructions for execution by PED 120 and that cause PED 120 to perform any one or more of the methodologies of the present invention. The term “machine-readable medium” shall accordingly be taken to include, but not be limited to, solid-state memories, and optical and magnetic media.

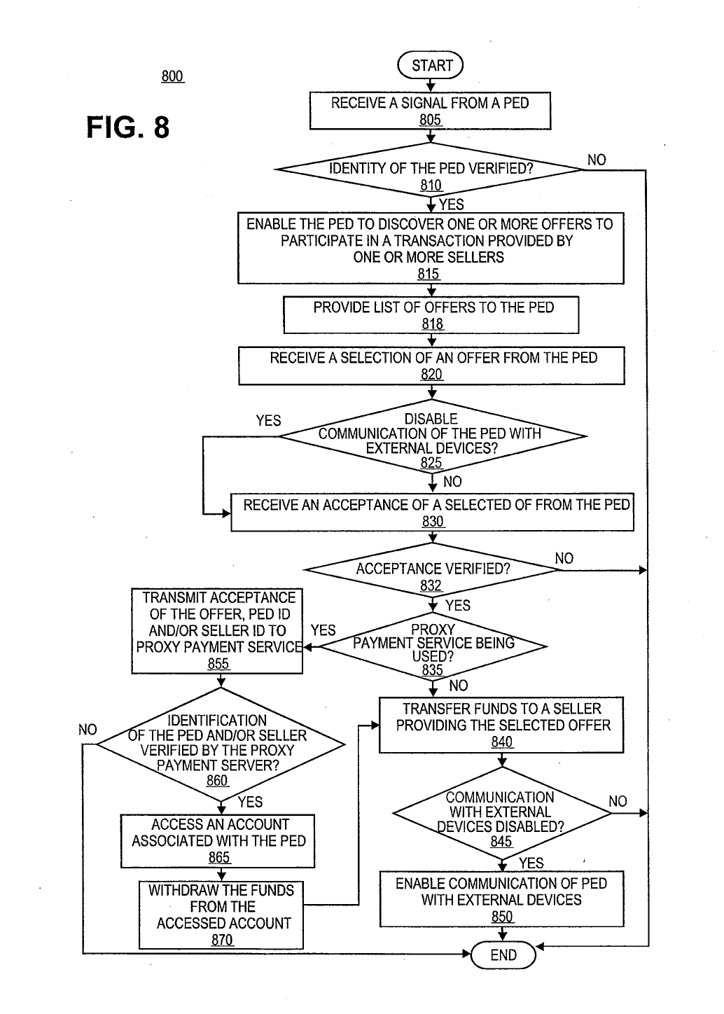

PED 120 may also include and/or be connected to token 125. Further details regarding token 125 are provided below with regard to FIGS. 8-10. In some embodiments, PED 120 may include a port 270 via which PED 120 may communicate with, for example, seller 110, frontline server 130, security and payment virtualization server 140, user account 150, and financial institutions A 170A and B 170B.

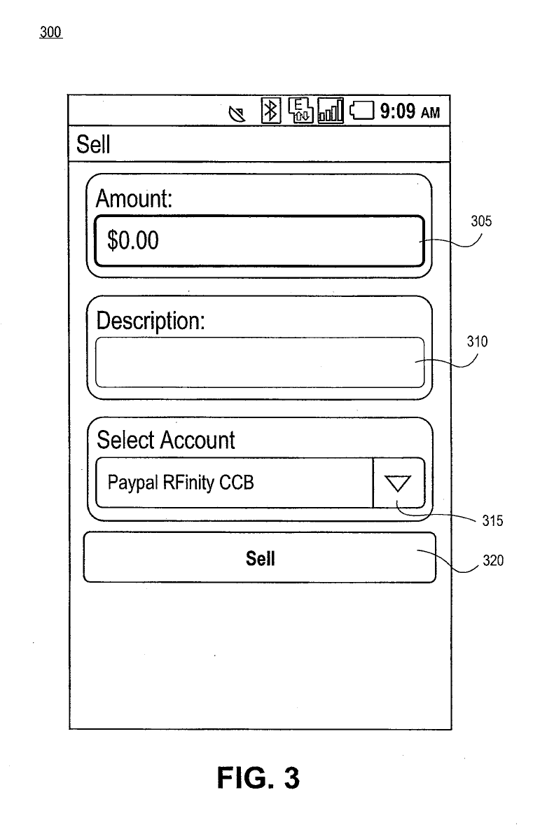

The GUIs of FIGS. 3-7 may be displayed on a PED, such as PED 120, via, for example, a software application downloaded and/or installed on the PED. In one embodiment, the software application may be compatible with, for example, one or more of the following operating systems; iOS™ as operable on, for example, an iPhone™ or iPad™, Android™, Windows Mobile™, Blackberry™, Nokia/Symbian™, and Java™-based systems. In some cases, the software application may be purchased from, for example, a traditional retail establishment and/or downloaded from an online store such as, Apple's™ App Store, iTunes™, and/or the Android Marketplace™.

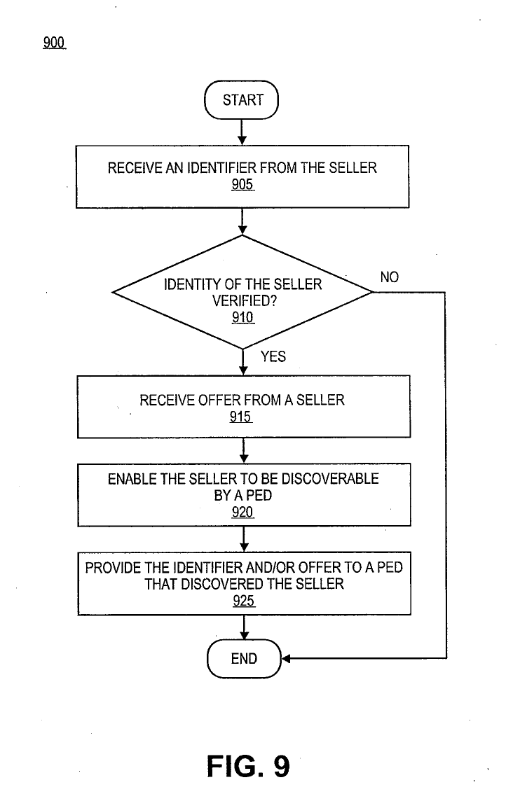

FIG. 3 is a block diagram illustrating an exemplary GUI 300 by which a seller, such as seller 110, may generate or modify an offer to participate in a transaction and transmit a generated offer to a server, such as frontline server 130. GUI 300 may be displayed upon any appropriate device, such as, a PED like PED 120, a computer, a laptop computer, a mobile communication device, a television, and a computer monitor. In some embodiments, GUI 300 may be used to execute, for example, some or all of process 900 as described below with reference to FIG. 9.

GUI 300 may include a number of data entry fields via which a seller may enter or modify information regarding the offer. For example, GUI 300 may include an amount text box 305, a description text box 310, a select account text box 315, and a selectable sell button 320. A seller may enter an amount of payment required for the sale of an item in amount text box 305. The amount may be expressed in, for example, currency, such as US dollars or yen, an amount of credit with a seller as with, for example, a gift card or merchandise credit, and/or an amount of earned increments of value, such as frequent flyer miles or Nintendo points.

A seller may enter a description of the offer into description text box 310. The description entered into description text box 310 may be of any length and may comprise, for example, alphanumeric text, images, and/or abbreviations. On some occasions, a description entered into description text box 310 may include terms and/or requirements, legal or otherwise, regarding the sale of an item.

A seller may select an account by which payment may be received for acceptance of the offer by a user or PED by entering the desired account into select account text box 315. In some embodiments, select account text box 315 may include a drop-down list of accounts selectable by the seller entering information into GUI 300. The accounts shown in the drop-down list may correspond to accounts available via a registration process previously executed by the seller with a server, such as frontline server 130. In at least one embodiment, select account text box 315 may also enable a seller to select an account via which a fee for generating and/or transmitting the offer is paid to the server in a fashion similar to, for example, paying for the posting of a for-sale advertisement. A seller may confirm the information entered into the GUI 300 and transmit be generated or modified offer to the server via selecting sell button 320.

In some embodiments, a previously entered offer may be accessed by the seller and entered into one or more text boxes of GUI 300. In this way, a seller who offers the same item for sale more than once does not have to enter the same description, amount, and/or account for each individual offer.

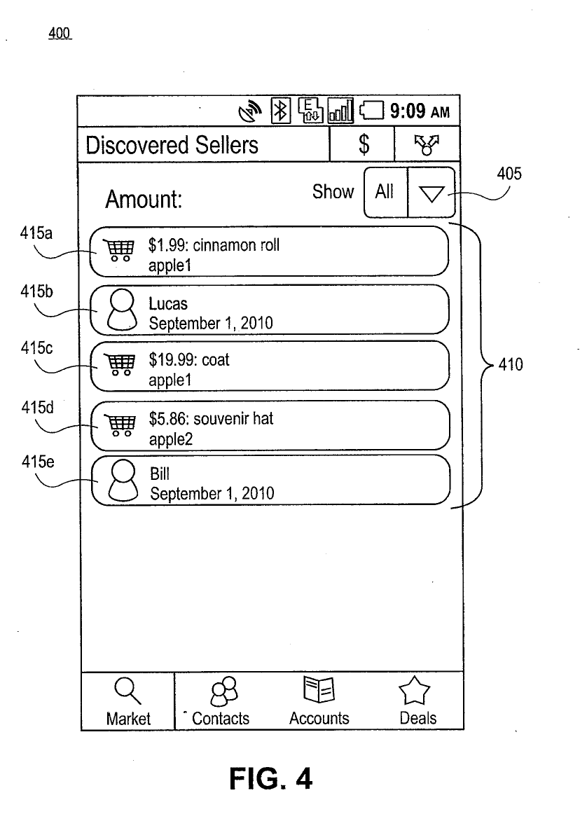

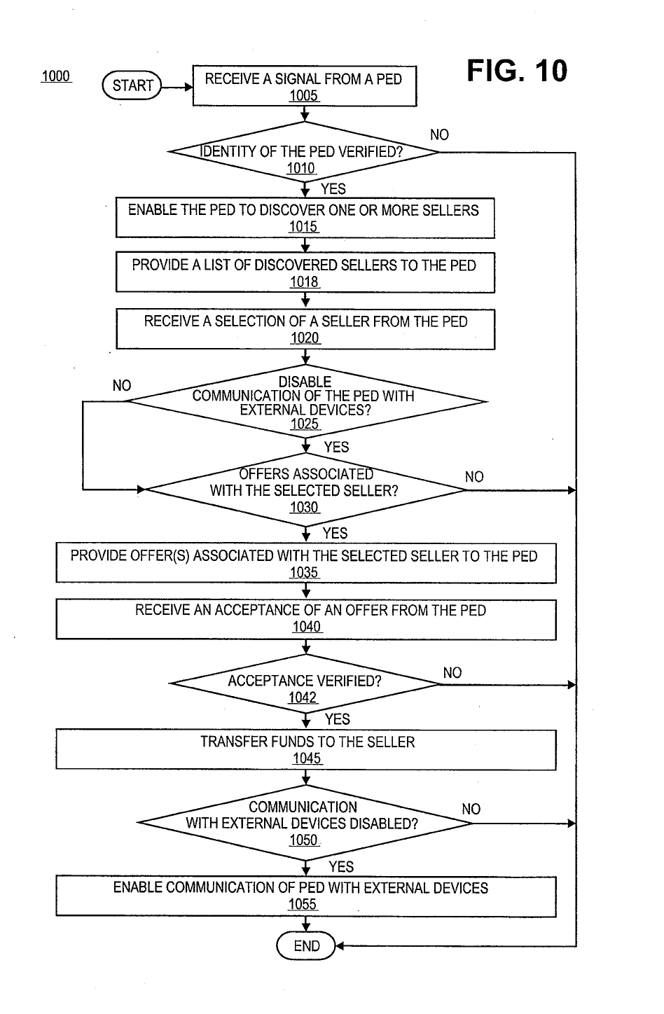

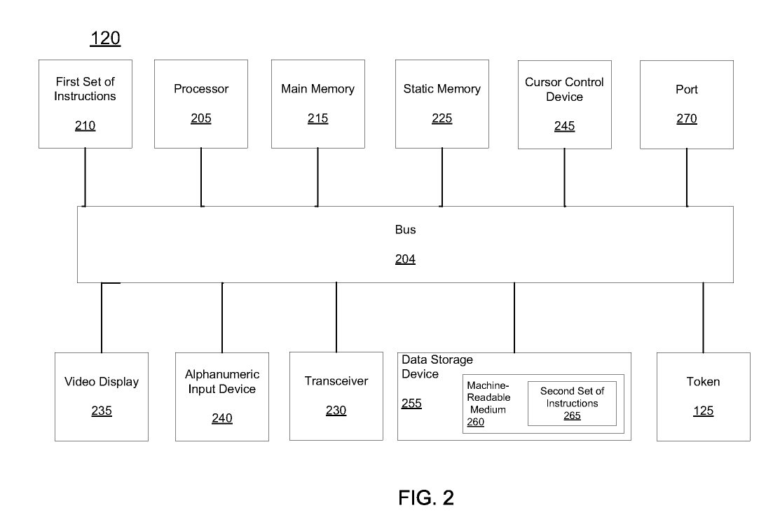

FIG. 4 is a block diagram illustrating an exemplary GUI 400 by which a user of a PED, such as PED 120, may view a list of discovered sellers and/or offers to participate in a transaction. GUI 400 may be displayed upon any appropriate device, such as, a PED like PED 120, a computer, a laptop computer, a mobile communication device, a television, and a computer monitor. In some embodiments, GUI 400 may be used to execute, for example, some or all of processes 800 and/or 1000 as described below with reference to FIGS. 8 and 10.

GUI 400 may include and a display mode button 405 for GUI 400, a list of discovered sellers and/or offers 410, and individual offers for participation in a transaction 415a-e. Display mode button 405 may be selected by a user in order to adjust the display of list of discovered sellers and/or offers 410. For example, display mode button 405 may provide a user with the ability to adjust the display of sellers and/or offers included in list 410 according to one or more parameters such as, cost, location of a seller, type of offer, price, terms of an offer, and description.

Sellers and/or offers 415a-e provided in list 410 may be selectable by a user of the PED via, for example, touching a position on a screen corresponding to a position of the selected offer on GUI 400 and positioning a cursor on a location corresponding to a seller/offer to be selected.

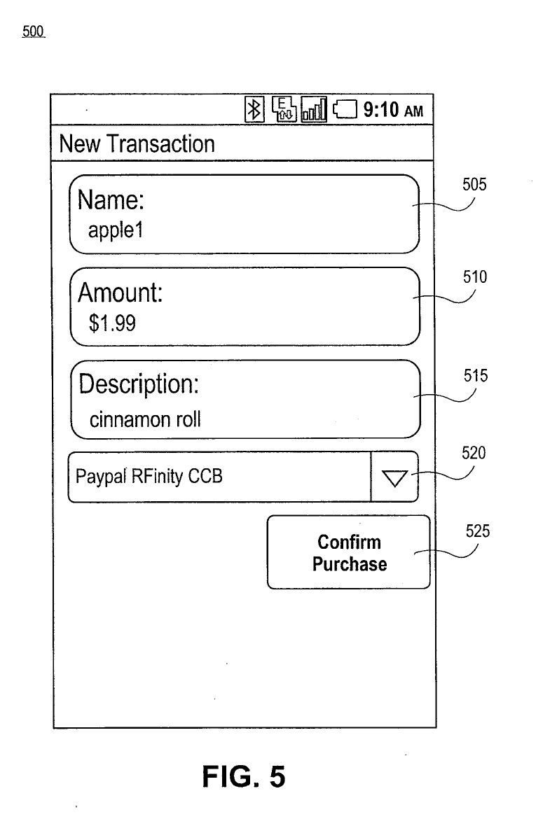

FIG. 5 is a block diagram illustrating an exemplary GUI 500 showing details relating to a seller and/or offer selected via, for example, GUI 400. GUI 500 may be displayed upon any appropriate device, such as, a PED like PED 120, a computer, a laptop computer, a mobile communication device, a television, and a computer monitor. In some embodiments, GUI 500 may be used to execute, for example, some or all of processes 800 and/or 1000 as described below with reference to FIGS. 8 and 10.

GUI 500 may include a name text box 505, an amount text box 510, a description text box 515, an account selection text box 520, and a confirmed purchase button 525. For illustrative purposes, the details shown in GUI 500 correspond to seller and/or offer 415a as displayed in list 410 of GUI 400.

Name text box 505 may include a name of a seller associated with a selected seller and/or offer. Amount text box 510 may include a price for accepting a selected offer. Description text box 515 may include a description of a selected offer. A user of the PED may enter an account from which payment may be withdrawn for acceptance of the offer into account selection text box 520. In some embodiments, account selection text box 520 may include a drop-down list of accounts selectable by a user of the PED by which acceptance of the offer may be paid for in whole, or in part. Selection of confirmed purchase button 525 may initiate a confirmation of an acceptance of a selected offer by a user of the PED and may transmit this confirmation to, for example, a server, such as frontline server 130.

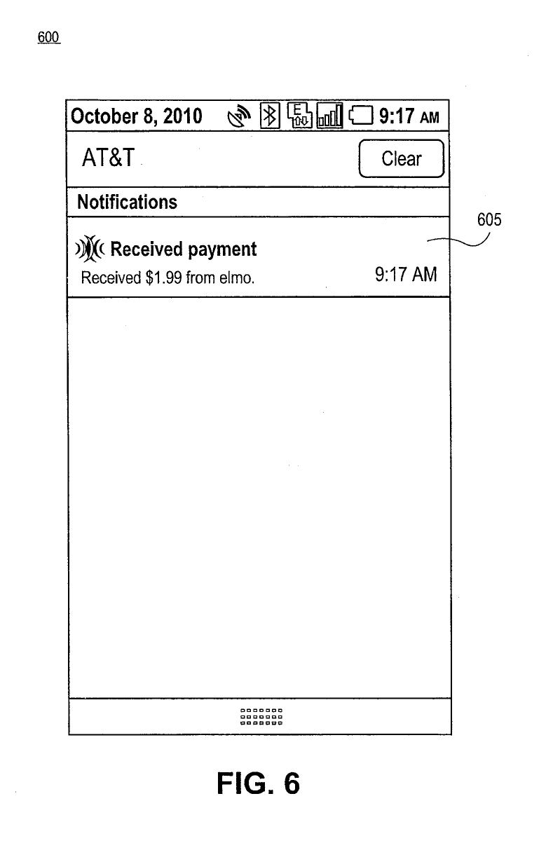

FIG. 6 is a block diagram illustrating an exemplary GUI 600 showing details relating to a confirmed acceptance of an offer associated with a seller viewing GUI 600. GUI 600 may be displayed upon any appropriate device, such as, a PED like PED 120, a computer, a laptop computer, a mobile communication device, a television, and a computer monitor. In some embodiments, GUI 600 may be used to execute, for example, some or all of processes 800 and/or 1000 as described below with reference to FIGS. 8 and 10.

GUI 600 may include a payment confirmation 605 indicating to, for example, a seller, that a PED confirmed acceptance of an offer associated with the seller. Payment confirmation 605 may include, for example, details regarding the acceptance such as purchase price paid, a description of the offer, and identification information associated with the PED that accepted the offer.

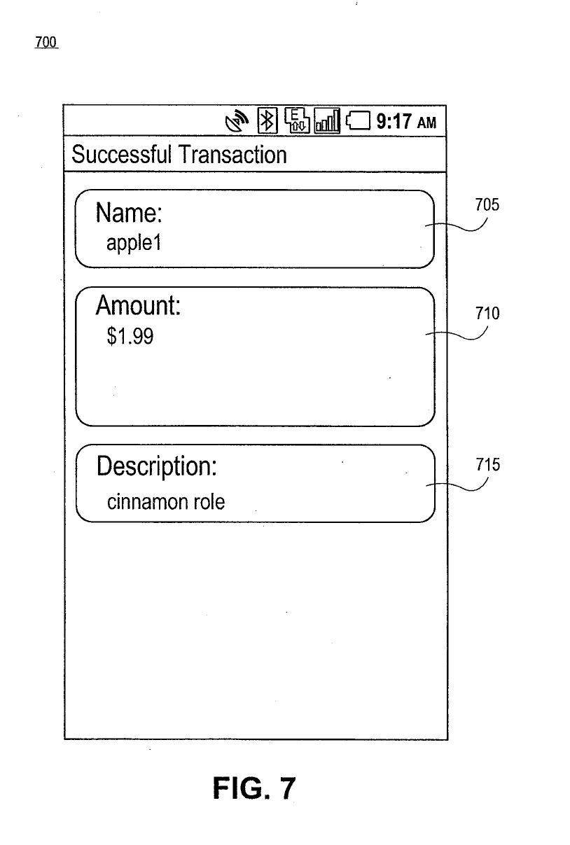

FIG. 7 is a block diagram illustrating an exemplary GUI 700 showing receipt of a successfully accepted offer. GUI 700 may be displayed upon any appropriate device, such as, a PED like PED 120, a computer, a laptop computer, a mobile communication device, a television, and a computer monitor. In some embodiments, GUI 700 may be used to execute, for example, some or all of processes 800 and/or 1000 as described below with reference to FIGS. 8 and 10.

GUI 700 may include a name text box 705, an amount text box 710, and a description text box 715. Information included in name text box 705, amount text box 710, and/or description text box 715 may correspond to an accepted offer and may act as a receipt for the accepted offer.

FIG. 8 is a flowchart illustrating an exemplary process 800 for executing a transaction between a PED and a seller. Process 800 may be executed by, for example, any of the systems and/or devices described herein. Process 800 may also be executed via, for example, a GUI, such as GUIs 300-700.

Initially, at step 805, a signal from a PED, such as PED 120, may be received by, for example, a server, such as frontline server 130. In some cases, a computer software application and/or a GUI, such as GUIs 300-700, operating on the PED may be accessed, or launched, by a user of the PED and the signal may be sent by the PED to the server via the computer software application and/or GUI. The signal may include information, for example, identifying the PED and/or a user of the PED.

In step 810, an identity of the PED may be verified based on, for example, the received signal. The verification of step 810 may include, for example, a sign in, or other data entry process whereby a user enters identification information into the PED and that information is transmitted to, and later verified by, for example, the server according to, for example, previously entered account information for the PED and/or user of the PED. Exemplary identification information includes information generated by a token, a personal identification number (PIN), and a password (commonly more complex than a PIN). Exemplary tokens may include, for example, a smart chip security module in an embedded or removable form factor such as a microSD card, as described in U.S. patent application Ser. Nos. 11/745,319, 11/948,272, 12/188,284, 12/196,669, and 12/196,806, the disclosure of each of which is hereby incorporated in its entirety into the present application.

In one embodiment, execution of step 810 may include a communication of identity credentials stored on the PED to the server, like frontline server 130. Exemplary stored credentials include PED configuration information (e.g., mobile phone number, a service provider identifier, a serial number), information associated with a user of the PED (e.g., a PIN or biometric information), and account information associated with an account the PED and/or a user of the PED has with the server. In one case, stored credentials related to a particular PED might be deleted, removed, invalidated, deactivated on the server, or ‘zeroized’ by an authorized user or manager of the server upon request. Such a request may be made upon, for example, loss of the PED, transference of the PED to another user, removal of a subscriber identity module (SIM) card or security module from the PED, insertion of a new SIM card or security module into the PED, loss of power to the PED, the PED being transported into or out of a predefined geographic area, detection of unauthorized activity on the PED, and/or connection of the PED to a communication network other than those in an authorized network.

When the identity of the PED is not verified, process 800 may end. When the identity of the PED is verified, the PED may be enabled in step 815 to discover one or more sellers and/or offers to participate in a transaction provided by one or more sellers. The discovery of a seller may occur via, for example, exchanging information with a seller via, for example, a wireless communication protocol, Bluetooth communication, WiFi communication, cell phone identifier discovery, near field communication (NFC) chip identifier discovery, radio frequency identifier discovery, location-based discovery, and global positioning (GPS) discovery. For example, a PED may scan for all sellers it can see via, for example, a wireless communication protocol. The PED may then transmit identification information associated with discovered sellers to the server for correlation with any offers associated with discovered sellers.

In some cases, execution of step 815 may include discovering, by the PED, identification information for one or more sellers and transmitting the discovered identification information to the server. Once received, the server may determine whether an offer for participation in a transaction is associated with a discovered seller. An offer may be generated, modified, and/or associated with a seller via process 900 as discussed below with regard to FIG. 9. The server may then prepare a list of offers associated with a discovered seller and transmit this list to the PED (step 818). The list of offers may then be displayed on the PED as in, for example, GUI 400.

Next, in step 820, a selection of an offer may be received by the server from the PED. The selection may be made by any available means, such as moving a cursor device or pressing on a touchscreen to select an offer from the list of offers. In some embodiments, selection of an offer may trigger a display of transaction details, such as terms and conditions, related to acceptance of the offer.

Optionally, in step 825, it may be determined whether to disable communication between the PED and an external device not directly involved in execution of process 800. For example, when the PED is a mobile telephone, communication between the PED and a Bluetooth headset communicatively coupled to the PED may be temporarily disabled during execution of process 800. Communication may be disabled in step 825 for security purposes so that communication relating to the acceptance of an offer cannot be detected by, for example, an unauthorized entity or hacker.

Whether communication is disabled in step 825 or not, in step 830, an acceptance of a selected offer may be received by the server from the PED. In one embodiment, step 830 may be executed by a user selecting, for example, an “OK,” “buy,” or “confirm purchase” button provided on a GUI, such as the “confirm purchase” button provided on GUI 500.

Once received, the acceptance may be verified (step 832). This verification may include verification of, for example, the accepted offer, the identity of a user of the PED, such as user 105, an account associated with the user for the PED, such as user account 150, and/or the identity of the seller. In one embodiment, the verification of step 832 may require the user of the PED to enter personally identifying information, such as a password or PIN. In another embodiment, the verification of step 832 may include verifying that sufficient funds are available in an account by which the user of the PED intends to transfer funds to the seller in order to complete the transaction. In yet another embodiment, the verification of step 832 may include verifying the validity of the selected offer by, for example, determining whether the selected offer meets one or more requirements (e.g., security and/or legal). For example, a PED associated with a user that is known to be 20 years old may not be used to accept an offer to purchase alcoholic spirits from a seller where a legal requirement restricts the selling of alcoholic spirits to individuals under 21 years of age. In another example, a seller may be required to provide information (e.g., a digital signature or password) according to, for example, one or more security protocols to, for example, the PED and/or server.

Next, in step 835, it may be determined whether a proxy payment service is being used to facilitate the transfer of funds from the PED and/or an account associated with the PED to the seller or a seller account. When a proxy payment service is not being used, the server may access an account associated with the PED and withdraw funds from the accessed account (step 840). Exemplary withdrawn funds include currency (e.g., US dollars or Yen) credit with a seller as with, for example, a gift card or merchandise credit, and earned increments of value, such as frequent flyer miles and Nintendo points. The amount of withdrawn funds may correspond to an amount required by the offer in order to complete the transaction.

In step 845, it may be determined whether communication between the PED and external devices was disabled as in, for example, step 825. When communication has not been disabled, process 800 may end. When disabled, communication between the PED and external devices may be enabled (step 850). Following step 850, process 800 may end.

Optionally, a user of a PED and/or a seller may enroll in an account with a proxy payment system, such as security and payment virtualization server 140 and/or server 130 prior to the execution of process 800. The terms of enrollment may be dictated by, for example, the proxy payment system, server, seller, and/or user. Enrollment into this account may include, for example, submission of user identification information and submission of information associated with a user's account with a financial institution, such as financial institution 170A and/or 170B, to the proxy payment service according to, for example, a security protocol or legal requirement.

When a proxy payment service is being used (step 835), acceptance of the offer, PED identifying information, and/or seller identifying information may be transmitted to the proxy payment service (step 855). On some occasions PED identifying information may be received by the server at step 805 and/or 810 and transmitted to the proxy payment service. In one embodiment, the proxy payment service and/or a financial institution may require additional identifying information from, for example, the PED and/or the seller. Exemplary additional information includes a name, an address, a phone number, an account number, an email address, a PIN, information specific to an account with the proxy payment system, information specific to an account with a financial institution in communication with the proxy payment system, a token, and information specific to the PED (e.g., configuration information or serial number).

In step 860, the identity of the PED and/or seller may be verified. The verification of step 860 may be executed by, for example, the proxy payment system, the financial institution, and/or some combination thereof.

On some occasions, the verification of step 860 may be conducted according to one or more requirements of the proxy payment system and/or financial institution. Execution of step 860 may include for example, determining the accuracy of received identification information and looking up submitted identification information against account information maintained by, for example, the proxy payment system and/or financial institution. When the PED identity and/or the seller identity are not verified, process 800 may end.

When the PED identity and/or the seller identity are verified, an account with the proxy payment service and/or a financial institution may be accessed (step 865) and funds may be withdrawn from the accessed account (step 870). In some embodiments, the amount of funds withdrawn from the account may be dictated by the terms of the accepted offer. The withdrawn funds may then be transferred to the seller providing the selected offer via, for example, a seller account with, for example, the proxy payment service and/or a financial institution (step 840).

FIG. 9 is a flowchart illustrating an exemplary process 900 for receiving an offer to participate in a transaction from a seller. Process 900 may be executed by, for example, any of the systems and/or devices described herein. Process 900 may also be executed via, for example, a GUI, such as GUIs 300-700.

In step 905, an identifier may be received from a seller, such as seller 110. The identity of the seller may then be verified based on, for example, the received identifier (step 910). The verification of step 910 may include, for example, a sign in, or other data entry process whereby a seller enters identification information into, for example, the server and/or a device communicatively coupled to the server, and that information is verified by, for example, the server. Exemplary identification information includes information received from a token, a PIN, and a password. Exemplary tokens may include, for example, a smart chip security module in an embedded or removable form factor such as a microSD card.

In one embodiment, execution of step 910 may include the communication of identity credentials stored on a device of the seller to the server. In one case, stored credentials related to a particular seller may be deleted, removed, invalidated, deactivated on the server, or ‘zeroized’ by an authorized user or manager of the server upon request. Such a request may be made upon, for example, loss of the seller's device, transference of the seller's device to another seller, removal of a SIM card or security module from the seller's device, insertion of a new SIM card or security module into the seller's device, loss of power to the seller's device, the seller's device being transported into or out of a predefined geographic area, and/or connection of the seller's device to a communication network other than those an unauthorized network.

When the identity of the seller is not verified, process 900 may end. When the identity of the seller is verified, an offer to participate in a transaction may be received in a step 915 by, for example, the server from the seller. An exemplary offer may include identification information associated with the seller, a transaction identifier, and a description of the offer. Exemplary offers may also include one or more of the following; a description of an item, a price of an item, a quantity of items, a quantity of items available for sale, a seller identity, a logo, an icon representative of an item, a date, a range of dates, an offer to participate in an auction for the purchase or sale of an item, an expiration date, a location, a discount, an offer to become a member in an organization, and a coupon.

Next, in step 920, the server may enable the seller to be discoverable by a PED using, for example, seller identification information and/or information included in the offer. For example, when identification information included in the offer is a Bluetooth ID, the server may enable a PED scanning for offers via the Bluetooth communication protocol to recognize the seller when the scan detects the Bluetooth ID of the seller.

Finally, the server may provide the identifier of the seller and/or an offer associated with the seller to a PED that discovered the seller in a step 925 via, for example, process 800 and/or 1000. Following step 925, process 900 may end.

FIG. 10 is a flowchart illustrating an exemplary process 1000 for executing a transaction between a PED and a seller. Process 1000 may be executed by, for example, any of the systems and/or devices described herein. Process 1000 may also be executed via, for example, a GUI, such as GUIs 300-700.

Initially, at step 1005, a signal from a PED, such as PED 120, may be received by, for example, a server, such as frontline server 130. Then, in step 1010, an identity of the PED may be verified based on, for example, the received signal. Steps 1005 and 1010 may be executed in a manner similar to steps 805 and 810 as discussed above with regard to FIG. 8.

When the identity of the PED is not verified, process 1000 may end. When the identity of the PED is verified, the PED may be enabled to discover one or more sellers in a step 1015 via, for example, exchanging information with a seller via, for example, a wireless communication protocol, Bluetooth communication, WiFi communication, cell phone identifier discovery, near field communication (NFC) chip identifier discovery, radio frequency identifier discovery, location-based discovery, and global positioning (GPS)-discovery. For example, a PED may scan for all sellers it can detect via, for example, a wireless communication protocol. The PED made then transmit identification information associated with discovered sellers to the server for correlation with any offers associated with discovered sellers.

In some cases, execution of step 1015 may include discovering, by the PED, identification information for one or more sellers and transmitting the discovered identification information to the server. Once received, the server may then prepare a list of discovered sellers and provide this list to the PED in a step 1018. The list of sellers may then be displayed on the PED.

Next, in step 1020, a selection of a seller may be received by the server from the PED. The selection may be made by, for example, a user moving a cursor device or pressing on a location of a touchscreen to select a seller from the list of sellers. In some embodiments, selection of a seller may trigger a display of transaction details related to the seller.

Optionally, in step 1025, it may be determined whether to disable communication between the PED and an external device not directly involved in execution of process 1000. For example, when the PED is a mobile telephone, communication between the PED and a Bluetooth headset communicatively coupled to the PED may be temporarily disabled during execution of process 1000.

Whether communication is disabled in step 1025 or not, in step 1030, it may be determined whether any offer(s), like the offer generated in process 900, are associated with the selected seller and, if not, process 1000 may end. When an offer is associated with the selected seller, the server may provide the offer to the PED (step 1035). An acceptance of a provided offer may then be received by the server from the PED (1040). In one embodiment, step 1040 may be executed by a user selecting an “OK,” “buy,” or “confirm purchase” button provided on a GUI, such as the “confirm purchase” button provided on GUI 500.

In some embodiments, it may be determined whether a proxy payment service is being used to facilitate the transfer of funds from the PED and/or a user associated with the PED to the seller. When this is the case, a process similar to that of steps 855-870 as discussed above with regard to FIG. 8 may be executed.

Then, in step 1045, the server may access an account associated with the PED and withdraw funds from the accessed account. Exemplary withdrawn funds include currency, credit with a seller as with, for example, a gift card or merchandise credit, and earned increments of value, such as frequent flyer miles and Nintendo points.

Optionally, in step 1050, it may be determined whether communication between the PED and external devices was disabled as in, for example, step 1025. When communication has not been disabled, process 1000 may end. When disabled, communication between the PED and external devices may be enabled (step 1055). Following step 1055, process 1000 may end.

Thus, systems, methods, GUI, apparatus, and computer-readable media for providing a secure, proximity based peer-to-peer payment transaction service have been herein disclosed.

What is claimed is:

1. A method comprising:
receiving, by a server, a signal from a personal electronic device (PED);
verifying, by the server, an identity of the PED based on the received signal;
upon verification of the PED, enabling, by the server, the PED to discover one or more offers to participate in a transaction provided by one or more sellers;
receiving, by the server, a selection of at least one of the offers from the PED;
receiving, by the server, an acceptance of a selected offer from the PED; and
transferring, by the server, funds to a seller providing the selected offer.

2. The method of claim 1, wherein the discovery of the one or more offers comprises:
scanning, by the PED, for the one or more sellers;
receiving, by the PED, a signal from at least one seller, the signal comprising:
identification information associated with the seller;
a transaction identifier;
an offer to participate in the transaction.

3. The method of claim 1, further comprising:
receiving, at the server, the offer from the seller, the offer comprising:
identification information associated with the seller;
a transaction identifier; and
a description of the offer.

4. The method of claim 3, further comprising:
upon receipt of the offer, enabling, by the server, the seller to be discoverable by the PED.

5. The method of claim 1, further comprising:
verifying, by the server, the identity of a seller providing the selected offer.

6. The method of claim 1, further comprising:
receiving, by the server, an identifier from the seller; and
providing, by the server, the identifier to the PED.

7. The method of claim 1, further comprising:
enabling communication only between the PED, seller, and server until the transfer of funds to the seller is complete.

8. The method of claim 1, wherein the verification of identity of the PED further comprises:
receiving, at the server from the PED, at least one of a token, a personal identification number (PIN), and a password; and
verifying, by the server, the received at least one token, personal identification number (PIN), and password.

9. The method of claim 1, wherein the verification of identity of the PED further comprises:
accessing, by the server, credentials associated with the PED; and
verifying, by the server, the accessed credentials.

10. The method of claim 1, further comprising:
transmitting, by the server, the acceptance of the offer to a proxy payment service;
verifying the identification of the PED by the proxy payment service;
upon verification of the identity of the PED:
accessing, by the proxy payment service, an account with a financial institution associated with the PED; and
withdrawing the funds from the accessed account; and
transferring, by the proxy payment service, the withdrawn funds to an account with a financial institution associated with the seller.

11. The method of claim 1, wherein the funds are transferred from an account with a financial institution associated with the PED to an account with a financial institution associated with the seller.

12. The method of claim 1, wherein the PED is enabled to discover the one or more sellers via at least one of a wireless communication protocol, Bluetooth communication, WiFi communication, cell phone identifier discovery, near field communication (NFC) chip identifier discovery, radio frequency identifier discovery, location-based discovery, and global positioning (GPS) discovery.

13. The method of claim 1, wherein the offer includes at least one of a description of an item, a price of an item, a quantity of items, a quantity of items available for sale, a seller identity, a logo, an icon representative of an item, a date, a range of dates, an offer to participate in an auction for the purchase or sale of an item, an expiration date, a location, a discount, an offer to become a member in an organization, and a coupon.

14. The method of claim 1, wherein communication between at least one of the server and the PED and the server and the seller are executed via a security protocol.

15. The method of claim 1, wherein the signal, selection, and acceptance of the offer are received at the server via a device other than the PED.

16. The method of claim 15, wherein the signal, selection, and acceptance are not stored on the device other than the PED.

17. The method of claim 1, wherein the PED is at least one of a portable communication device, a mobile telephone, a laptop computer, a tablet computer, a computerized wristwatch, and a portable music player.

18. The method of claim 1, further comprising:
verifying, by the server, the acceptance of the offer.

19. A method comprising:
receiving, by a server, a signal from a PED;
verifying, by the server, an identity of the PED based on the received signal;
enabling, by the server, the PED to discover one or more sellers;
receiving, by the server, a selection of at least one of the sellers from the PED;
determining, by the server, whether any offers to participate in a transaction are associated with the at least one seller and, if so, providing the offers to the PED;
receiving, by the server, an acceptance of the offer from the PED; and
transferring, by the server, funds to the seller by the server.

20. A graphical user interface (GUI) presented to a user via a personal electronic device (PED), the GUI comprising:
a first selectable option for sending a signal from the PED to a server;
a selectable list of offers to participate in a transaction provided by one or more sellers discoverable by the PED; and
a second selectable option for accepting at least one offer included in the list of offers.

21. The GUI of claim 20, further comprising:
a first text box via which a seller enters information associated with at least one offer included in the list of offers; and
a second text box via which the seller enters information associated with an account the seller has with a financial institution.

22. An apparatus configured to receive a signal from a personal electronic device (PED), verify an identity of the PED based on the received signal, enable, upon verification of the PED, the PED to discover one or more offers to participate in a transaction provided by one or more sellers, receive a selection of at least one of the offers from the PED, receive an acceptance of a selected offer from the PED, and transfer funds to a seller providing the selected offer.

23. A system comprising:
a personal electronic device (PED) configured to transmit a signal to a server, discover one or more offers to participate in a transaction provided by one or more sellers, transmit a selection of at least one of the offers to the server, and transmit an acceptance of a selected offer to the server; and
a server communicatively coupled to the PED and configured to receive a signal from a personal electronic device (PED), verify an identity of the PED based on the received signal, enable, upon verification of the PED, the PED to discover the one or more offers to participate in a transaction provided by the one or more sellers, receive a selection of at least one of the offers from the PED, receive an acceptance of a selected offer from the PED, and transfer funds to a seller providing the selected offer.
